(19) United States
(12) Patent Application Publication
(10) Pub. No.: US 2020/0085077 A1
(43) Pub. Date: Mar. 19, 2020

(54) INSTANT SMORES SYSTEM AND METHOD

(71) Applicant: Bobby Joe Ingram, Sherwood Park (CA)

(72) Inventor: Bobby Joe Ingram, Sherwood Park (CA)

(21) Appl. No.: 16/134,552

(22) Filed: Sep. 18, 2018

(51) Int. Cl. A23G 3/54; A23G 3/34; A23G 1/54

(52) U.S. Cl. CPC A23G 3/54; A23V 2002/00; A23G 1/54; A23G 3/0019

(57) ABSTRACT

An instant smores system including: a sugar-based confectionery having ingredients of sugar, water and gelatin whipped to a deformable (squishy) consistency, admixed with chocolate and graham and molded into pieces, and coated with corn starch to provide an edible smore of the proper consistency for heating and consumption. The smore is safe to eat and is easy to transport and prepare.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of food or edible material: processes, compositions, and products of existing art and more specifically relates to an instant smores system.

### RELATED ART

Many individuals enjoy cooking smores for entertainment and to eat. Smores typically have 3 individual parts that are not easy to buy, store, ship and transport. The crackers and chocolate usually get broken which makes it difficult to provide an appealing end product. Smores may be difficult to make since the individual (typically a child) roasts the marshmallow and then takes the hot sticky burning marshmallow to combine it with the unheated crackers and chocolate and hope the ingredients all melt and combine for the perfect smore. The actions required may be very challenging for kids to do without supervision. Children may also get burned in the process which is not desirable. A suitable solution is desired.

U.S. Pat. No. 6,296,884 to David F. Okerlund relates to a pre-packaged s'more kit. The described pre-packaged s'more kit includes a plurality of marshmallows, crackers, and flavored wafers shaped to fit inside an elongated container. Preferably, the kit includes a roasting utensil also designed to fit within the elongated container. Once the s'more ingredients are removed, the elongated container can be reused as a storage container, a drinking cup, even a refractory telescope. Advantageously, a s'more connoisseur need only purchase one easily storable and transportable kit Instead of separately purchasing the ingredients in bulk.

### SUMMARY OF THE INVENTION

In view of the foregoing disadvantages inherent in the known food or edible material: processes, compositions, and products art, the present disclosure provides novel instant smores system. The general purpose of the present disclosure, which will be described subsequently in greater detail, is to provide an efficient and effective smore product for consumption.

An instant smores system is disclosed herein comprising: a sugar-based confectionery comprising ingredients of sugar, water and gelatin whipped to a deformable (squishy) consistency, admixed with chocolate and graham and molded into pieces, and coated with corn starch to provide an edible smore of the proper consistency for heating and consumption.

A method of use for the instant smores system is also disclosed herein, the method comprising the steps of: providing a sugar-based confectionery comprising ingredients of sugar, water and gelatin whipped to a deformable consistency, admixed with chocolate and graham and molded into pieces, and coated with corn starch to provide an edible smore for heating and consumption; piercing the edible smore; and cooking the edible smore over an open fire. The method may further comprise the step of sandwiching the edible smore after melted.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a instant smores system, constructed and operative according to the teachings of the present disclosure.

FIG. 1 is a perspective view of the instant smores system during an ‘in-use’ condition, according to an embodiment of the disclosure.

FIG. 2 is a perspective view of the instant smores system of FIG. 1, according to an embodiment of the present disclosure.

FIG. 3 is a perspective view of the instant smores system of FIG. 1, according to an embodiment of the present disclosure.

FIG. 4 is a perspective view of the ingredients of the instant smores system of FIG. 1, according to an embodiment of the present disclosure.

FIG. 5 is a flow diagram illustrating a method of use for the instant smores system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to food or edible material: processes, compositions, and products and more particularly to an instant smores system as used to improve the process and entertainment of smore making.

Generally, the present invention comprises instant smores marshmallows, graham cracker, chocolate all in one. Instant Smores combines the graham cracker and chocolate all together into the marshmallow for easier use and less packaging and less storage space. It combines all the ingredients of the smore into one easy to use, ship, store, and transport package. All the user-consumer has to do is put the combined smore marshmallow onto a cooking stick and he/she is ready to prepare the smore for heated consumption; no mixing, breakage or combining of the individual ingredients as it is all in one. Easier to buy, store and transport, easier to use for young and old, better heating and mixing of all the individual parts for a better more consistent product.

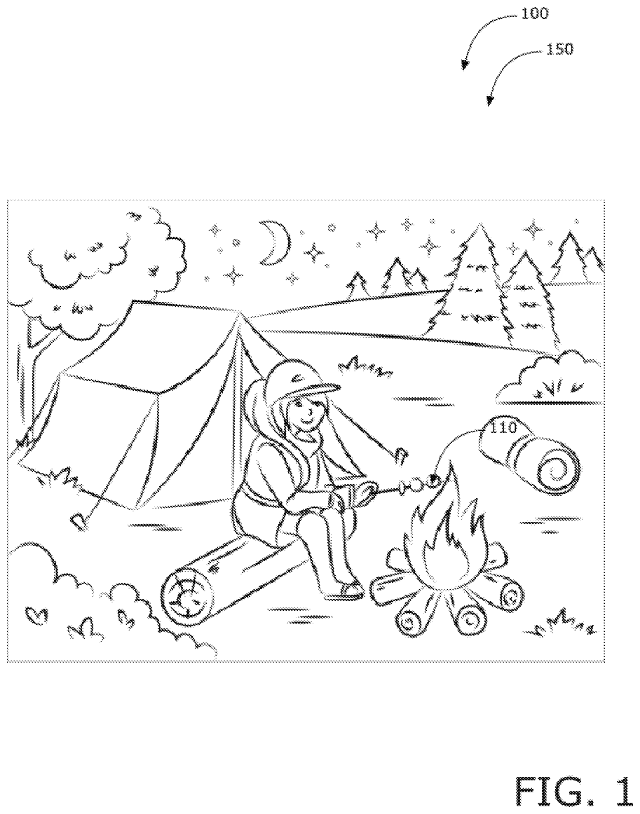

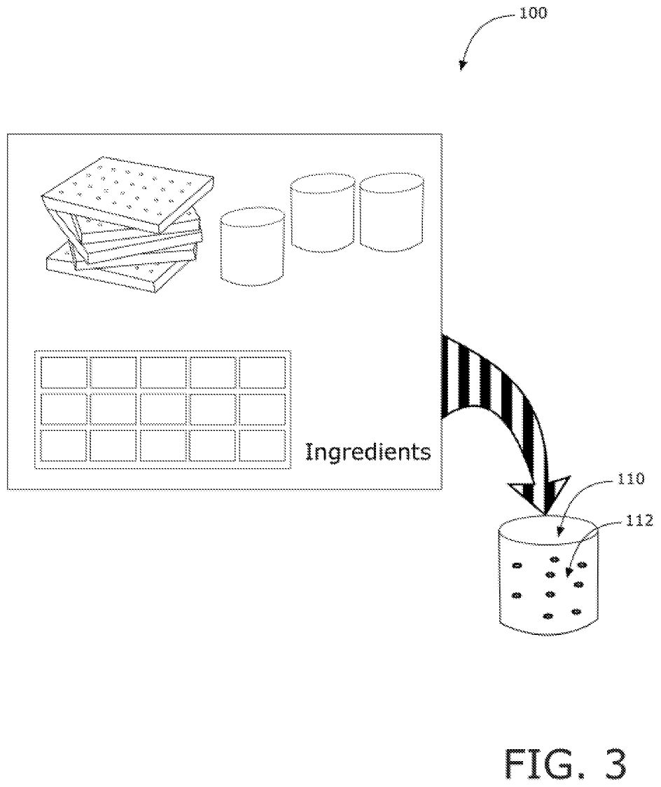

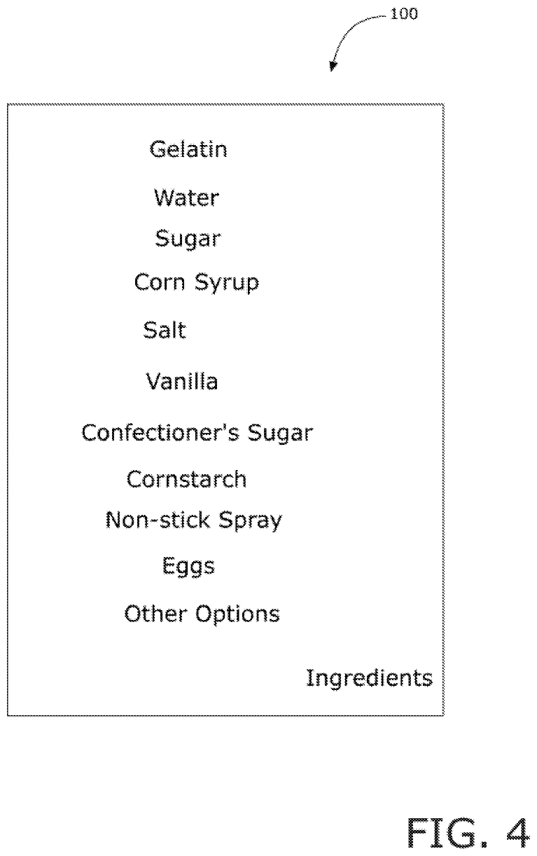

Referring now more specifically to the drawings by numerals of reference, there is shown in FIGS. 1-4, various views of an instant smores system 100.

FIG. 1 shows an instant smores system 100 during an ‘in-use’ condition 50, according to an embodiment of the present disclosure. Here, the instant smores system 100 may be beneficial for use by a user to provide a safe, healthy edible treat. As illustrated, the instant smores system 100 may include a sugar-based confectionery comprising ingredients of sugar, water and gelatin whipped to a deformable consistency, admixed with chocolate and graham and molded into pieces 112, and coated with corn starch to provide an edible smore 110 for heating and consumption, as shown in FIG. 1.

According to one embodiment, the instant smores system 100 may be arranged as a kit. In particular, the instant smores system 100 may further include a set of instructions. The instructions may detail functional relationships in relation to the structure of the instant smores system 100 such that the instant smores system 100 can be used, maintained, or the like, in a preferred manner.

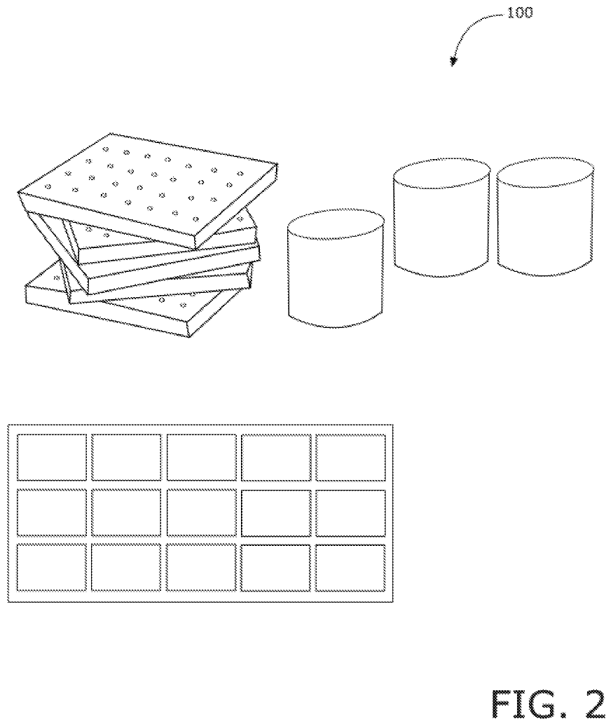

Referring now to FIGS. 2-4 showing various views of the instant smores system 100 of FIG. 1, according to an embodiment of the present disclosure.

The ingredients of the instant smores system may comprise in the following single batch amounts: 3 packages unflavored the gelatin; 1 cup ice cold the water, divided; 12 ounces granulated sugar; 1 cup light corn syrup; ¼ teaspoon kosher salt; 1 teaspoon vanilla extract; ¼ cup confectioners'-sugar; ¼ cup of the cornstarch; and non-stick spray; the ingredients are admixed in proportion with the chocolate and the graham and molded into pieces. Many different recipes may be used and the one provided is not intended to be limiting but rather as an exemplary means to provide enablement of the present invention. The recipe may further comprise eggs.

In particular, other embodiments may include one or more flavoring agents added to the recipe, or as part of the chocolate or graham. Also, additional ingredients may be substituted or added to the recipe. For example, the chocolate may be replaced by a chocolate confectionary bar or the like to provide variants in flavor and texture e.g. pieces of a caramel-filled chocolate bar of a nut-filled chocolate bar may be used. In this sense, it is to be understood that chocolate as described herein included not only pure varieties of chocolates (milk, dark, white), but also mixtures thereof, and mixtures which are primarily chocolate with other edible ingredients (nuts, fruit, wafers, etc.). The recipe may also be modified to account for dietary restrictions, such as gluten-free, vegetarian and/or vegan.

Referring now to the pieces 112, each of the pieces 112 may comprise a small cylindrical profile as manufactured to resemble a marshmallow, or alternatively have a small non-cylindrical profile such as 3-D cube, 3-D rectangle, oval or the like. The pieces may then be packaged individually, or collectively (e.g. packs of 4, 6, 12, etc.), or loosely together in a single bag, as is known with marshmallows.

The graham is preferably granular such that it can be evenly distributed within the edible smore 110; wherein the graham is mixed integrally in the instant smores system 100 and then molded into the edible smore 110. In certain embodiments (layered) the graham may be located at each end of the edible smore 110. The chocolate is mixed integrally in the instant smores system 100 and then molded into the edible smore 110; but again may be layered if different orientation is desired. The ingredients are mixed such that when the edible smore 110 is presented is in (visible) layers and other embodiments are not in layers. The edible smore 110 is self-contained as to the ingredients such that it is easy to ship, store, and prepare. The edible smore 110 is able to be engaged by a piercing object to be heated and ‘cooked’ over an open fire. The edible smore 110 comprises a ‘marshmallow shell’ able to be cooked; wherein the marshmallow shell is able to be caramelized and the ingredients sufficiently heated for consumption at the same time. The caramelized temperature of the marshmallow shell is at a safe eating temperature for the edible smore 110 such that when heated is safe for child consumption. The edible smore 110 of the instant smores system is able to be sandwiched when melted for example in graham crackers if desired.

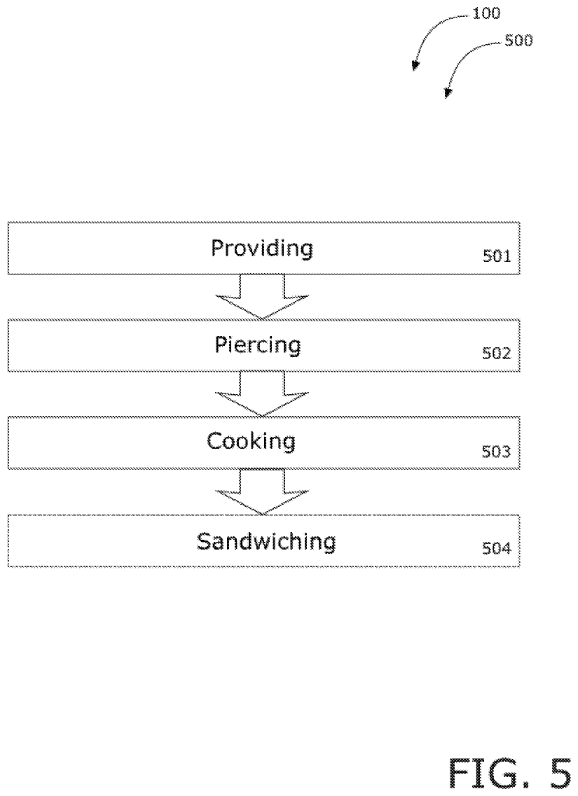

Referring now to FIG. 5 showing a flow diagram illustrating a method of use 500 for instant smores system 100, according to an embodiment of the present disclosure. In particular, the method of use 500 may include one or more components or features of the instant smores system 100 as described above. As illustrated, the method of use 500 may include the steps of: step one 501, providing a sugar-based confectionery comprising ingredients of sugar, water and gelatin whipped to a deformable consistency, admixed with chocolate and graham and molded into pieces, and coated with corn starch to provide an edible smore for heating and consumption; step two 502, piercing the edible smore; step three 503, cooking the edible smore over an open fire; step four 504, of sandwiching the edible smore after melted.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for preparing, particular recipe used, heating and cooking are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An instant smores system comprising:
a sugar-based confectionery comprising ingredients of sugar, water and gelatin whipped to a deformable consistency, admixed with chocolate and graham and molded into pieces, and coated with corn starch to provide an edible smore for heating and consumption.

2. The instant smores system of claim 1, further comprising eggs.

3. The instant smores system of claim 1, wherein each of said pieces comprise a small cylindrical profile.

4. The instant smores system of claim 1, wherein each of said pieces comprise a small non-cylindrical profile.

5. The instant smores system of claim 1, wherein the ingredients comprise in following single batch amounts:
3 packages unflavored said gelatin;
1 cup ice cold said water, divided;
12 ounces granulated sugar;
1 cup light corn syrup;
¼ teaspoon kosher salt;
1 teaspoon vanilla extract;
¼ cup confectioners'-sugar;
¼ cup of said cornstarch; and
non-stick spray;
said ingredients are admixed in proportion with said chocolate and said graham and molded into pieces.

6. The instant smores system of claim 5, wherein the graham is granular.

7. The instant smores system of claim 6, wherein the graham is mixed integrally in said instant smores system and then molded into said edible smore.

8. The instant smores system of claim 7, wherein the chocolate is mixed integrally in said instant smores system and then molded into said edible smore.

9. The instant smores system of claim 8, wherein the ingredients are mixed such that when said edible smore is presented is in layers.

10. The instant smores system of claim 8, wherein the ingredients are mixed such that when said edible smore is presented is not in layers.

11. The instant smores system of claim 9, wherein the edible smore is self-contained as to said ingredients.

12. The instant smores system of claim 1, wherein the edible smore is able to be engaged by a piercing object to be cooked over an open fire.

13. The instant smores system of claim 1, wherein the edible smore comprises a marshmallow shell able to be cooked.

14. The instant smores system of claim 1, wherein the marshmallow shell is able to be caramelized and said ingredients sufficiently heated for consumption at a same time.

15. The instant smores system of claim 14, wherein a caramelized temperature of said marshmallow shell is at a safe eating temperature for said edible smore.

16. The instant smores system of claim 15, wherein the edible smore is able to be sandwiched when melted.

17. An instant smores system comprising:
a sugar-based confectionery comprising ingredients of sugar, water and gelatin whipped to a deformable consistency, admixed with chocolate and graham and molded into pieces, and coated with corn starch to provide an edible smore for heating and consumption
wherein the graham is mixed integrally in said instant smores system and then molded into said edible smore;
wherein the chocolate is mixed integrally in said instant smores system and then molded into said edible smore;
wherein the edible smore is self-contained as to said ingredients;
wherein the edible smore is able to be engaged by a piercing object to be cooked over an open fire;
wherein the edible smore comprises a marshmallow shell able to be cooked;
wherein the marshmallow shell is able to be caramelized and said ingredients sufficiently heated for consumption at a same time; and
wherein a caramelized temperature of said marshmallow shell is at a safe eating temperature for said edible smore.

18. The instant smores system of claim 17, further comprising set of instructions; and
wherein the instant smores system is arranged as a kit.

19. A method of use for the instant smores system, the method comprising the steps of:
providing a sugar-based confectionery comprising ingredients of sugar, water and gelatin whipped to a deformable consistency, admixed with chocolate and graham and molded into pieces, and coated with corn starch to provide an edible smore for heating and consumption;
piercing said edible smore; and
cooking said edible smore over an open fire.

20. The method of claim 19, further comprising the step of sandwiching said edible smore after melted.
